(19) United States
(12) Patent Application Publication
(10) Pub. No.: US 2024/0291959 A1
(43) Pub. Date: Aug. 29, 2024

(54) PHOTOGRAPHING SYSTEM

(71) Applicant: LAPIS Technology Co., Ltd., Yokohama (JP)

(72) Inventors: Naoki NISHITANI, Yokohama (JP); Yuki IMATOH, Yokohama (JP)

(73) Assignee: LAPIS Technology Co., Ltd., Yokohama (JP)

(21) Appl. No.: 18/581,380

(22) Filed: Feb. 20, 2024

(30) Foreign Application Priority Data
Feb. 28, 2023 (JP) 2023-030362

(51) Int. Cl. H04N 17/00; H04N 23/60; H04N 23/611

(52) U.S. Cl. CPC H04N 17/002; H04N 23/611; H04N 23/64

(57) ABSTRACT

A photographing system includes: a camera; a processor, processing an image captured by the camera and outputting a notification signal; and a notification portion, notifying an outside that the notification signal has been received. The processor detects a moving body from the image, obtains a center of a moving range of the moving body, and outputs the notification signal when a shift amount of a center of a photographing range of the camera with respect to the center of the moving range of the moving body is less than or equal to a predetermined threshold value.

### CROSS-REFERENCE TO RELATED APPLICATION

This application claims priority under 35 USC 119 from Japanese Patent application No. 2023-030362 filed on Feb. 28, 2023, the disclosure of which is incorporated by reference herein.

### BACKGROUND

### Technical Field

The disclosure relates to a photographing system.

### Description of Related Art

Patent Document 1 (Japanese Patent Application Laid-Open (JP-A) No. 2020-186114) describes an image processing device that is mounted near the door of a car and is capable of detecting a shift in the mounting position of a camera that takes images including the inside of the car and the landing area. This image processing device includes an acquisition unit, a setting unit, an adjustment unit, and a detection unit. The acquisition unit is used for acquiring an image from the camera, which is captured in a state where a marker that may be distinguished from the floor surface of the car and the floor surface of the landing area is set; the setting unit is used for setting an area of interest in which the marker is estimated to appear on the acquired image based on the specification value regarding the mounting of the camera; the adjustment unit is used for adjusting the parameter of the camera based on the statistics regarding the pixel group included in the set area of interest; and the detection unit is used for acquiring the image captured after adjusting the parameter from the camera, recognizing the marker from the acquired image, and detecting a shift in the mounting position of the camera based on the recognized marker.

Meanwhile, a drive recorder is known as a photographing system for vehicles. Some drive recorders do not have a display. In the case of a drive recorder without a display, to check the mounting position and mounting angle to the vehicle, the images may be once recorded and transferred to a recording medium, which is then connected to another display device, and then the recorded images are checked and the mounting position and mounting angle are adjusted again. When a drive recorder without a display is installed in a vehicle in this manner, the process of adjusting the mounting position and mounting angle is complicated.

The disclosure provides a photographing system that allows easy adjustment of the mounting position and mounting angle without displaying the captured images.

### SUMMARY

The photographing system in one aspect of the disclosure includes a camera; a processor, processing an image captured by the camera and outputting a notification signal; and a notification portion, notifying an outside that the notification signal has been received. The processor detects a moving body from the image, obtains a center of a moving range of the moving body, and outputs the notification signal when a shift amount of a center of a photographing range of the camera with respect to the center of the moving range of the moving body is less than or equal to a predetermined threshold value.

### BRIEF DESCRIPTION OF THE DRAWINGS

FIG. 1 is a diagram showing the hardware configuration of the photographing system according to the embodiment of the disclosure.

FIG. 2 is a schematic side view of the vehicle showing a state in which the image recording device including the photographing system of FIG. 1 is temporarily mounted to the vehicle.

FIG. 3A is a diagram showing the image of the moving body captured with the camera included in the image recording device of FIG. 2.

FIG. 3B is a diagram showing the moving range of the moving body obtained from FIG. 3A.

FIG. 3C is a diagram showing the center of the moving range of the moving body shown in FIG. 3B and the center of the photographing range of the camera.

FIG. 3D is a diagram showing the areas (boundaries) where the notification level changes from the center of the moving range of the moving body.

FIG. 4 is a flow chart showing the image processing by the processor.

FIG. 5 is a flow chart showing the image processing of the photographing system according to another embodiment of the disclosure.

### DESCRIPTION OF THE EMBODIMENTS

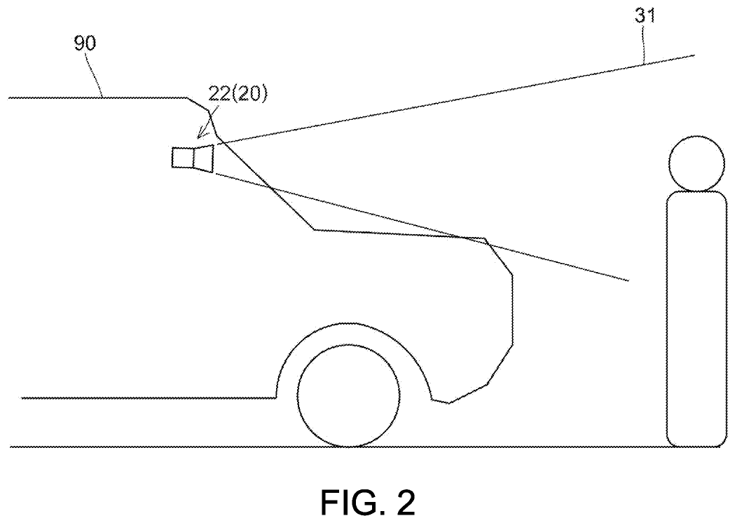

Hereinafter, an example of a photographing system according to the embodiment of the disclosure is described in detail with reference to the drawings. The photographing system 20 of this embodiment is used in the image recording device 22. The image recording device 22 is, for example, a drive recorder mounted inside a vehicle 90 (see FIG. 2).

By using the disclosure, a photographing system that allows easy adjustment of the mounting position and mounting angle without displaying the captured images may be provided.

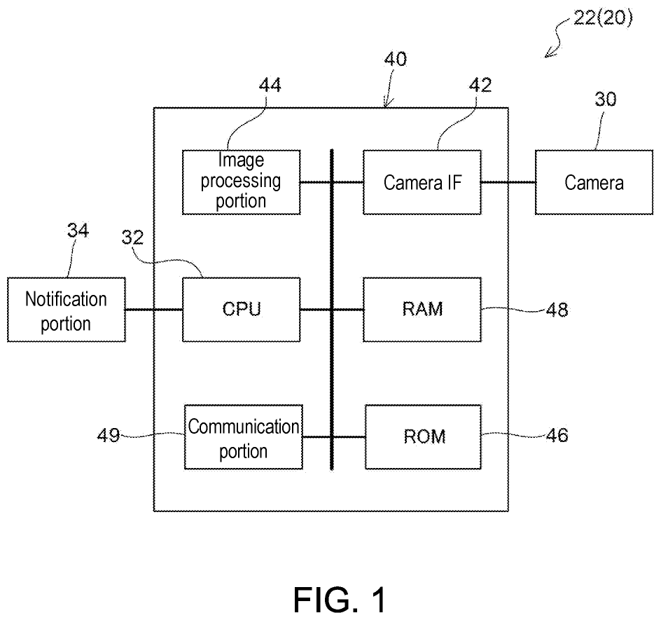

As shown in FIG. 1, the photographing system 20 of this embodiment includes a camera 30, a controller 40 including a CPU 32 as an example of a processor, and a notification portion 34.

The camera 30 have a function of capturing images, including videos. The camera 30 is mounted so as to face the front of the vehicle (see FIG. 2). Specifically, the camera 30, the CPU 32, and the notification portion 34 that configure the photographing system 20 of this embodiment are accommodated in one housing. Then, the housing is mounted to the front side of the vehicle inside the vehicle so that the camera 30 faces the front of the vehicle. It should be noted that this embodiment is not limited to this configuration. For example, the housing may be mounted to the rear side of the vehicle inside the vehicle so that the camera 30 faces the rear of the vehicle. Further, in this embodiment, although the camera 30, the CPU 32, and the notification portion 34 that configure the photographing system 20 are accommodated in one housing, they may also be accommodated in separate housings. Further, the camera 30 and the CPU 32 may be accommodated in one housing, and the notification portion 34 may be accommodated in another housing; or the camera 30 may be accommodated in one housing, and the CPU 32 and the notification portion 34 may be housed in another housing.

As shown in FIG. 1, the controller 40 includes a camera interface (IF) 42, an image processing portion 44, a CPU 32, a ROM 46, a RAM 48, and a communication portion 49.

The camera interface 42 is an interface for the signal with the camera 30.

The image processing portion (image signal processor) 44 has a function of processing the image captured by the camera 30.

The CPU 32 has a function of processing the image captured by the camera 30 and outputting a notification signal. Specifically, the CPU 32 further processes the image processed by the image processing portion 44. Further, the CPU 32 has a function of managing the system and managing image storage/deletion as the image recording device 22. The detailed functions of the CPU 32 are described later.

The ROM 46 has a function of storing the image processed by the image processing portion 44. The processed image is stored in this ROM 46 as a video file. When the free space in the ROM 46 runs out due to the storage of the video file, the oldest video file is deleted to ensure the free space, and a new video file is saved. It should be noted that the ROM 46 may be a recording medium that is removably attached to the image recording device 22, or may be a built-in type.

The RAM 48 functions as a data memory necessary for the operation of the CPU 32 and the image processing portion 44 and a memory for storing the program executed by the CPU 32.

The communication portion 49 has a wired or wireless communication function. Through this communication portion 49, the video file stored in the ROM 46 may be transferred to an external device. It should be noted that in the case where the ROM 46 is a removable recording medium, the communication portion 49 may be omitted.

The image recording device 22 of this embodiment is a drive recorder and is provided with various sensors such as an acceleration sensor. For example, when an acceleration equal to or higher than a predetermined value is detected by the acceleration sensor, the CPU 32 performs processing such as stopping the storage of the video file.

Further, in this embodiment, the driving power for the image recording device 22 is supplied by the battery of the vehicle 90.

The notification portion 34 has a function of notifying the outside that the notification signal has been received from the CPU 32. Specifically, the notification portion 34 notifies the outside that the notification signal is received from the CPU 32 using at least one of sound, light, and vibration.

Further, the notification portion 34 may be capable of adjusting a notification level to the outside in multiple stages according to the notification signal. Specifically, in the case where the notification portion 34 is configured to emit sound for notification, the notification level is adjusted depending on the interval between the sound and the volume of the sound. In addition, in the case where the notification portion 34 is configured to emit light for notification, the notification level is adjusted depending on the blinking interval of the light source that emits light and the light intensity (light amount). Further, in the case where the notification portion 34 is configured to emit vibration for notification, the notification level is adjusted depending on the vibration interval and the vibration intensity. It should be noted that the disclosure is not limited to this configuration. Any configuration may be used as long as the notification level to the outside may be adjusted in multiple stages according to the notification signal.

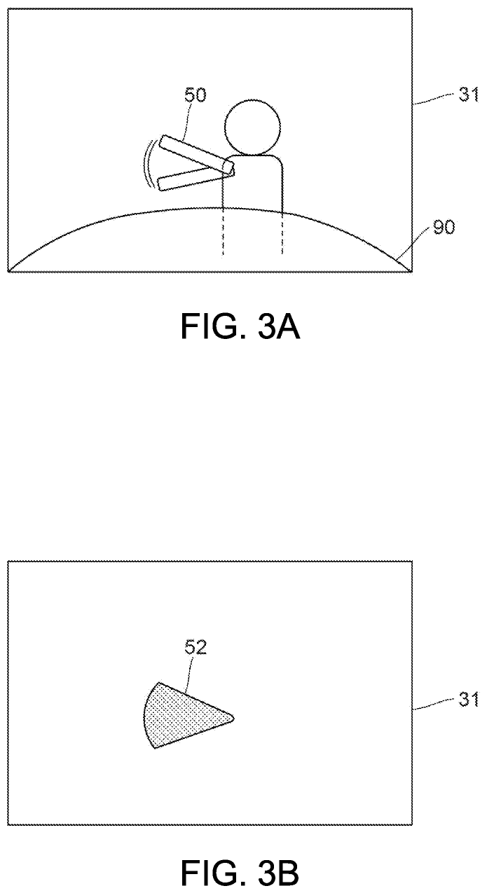

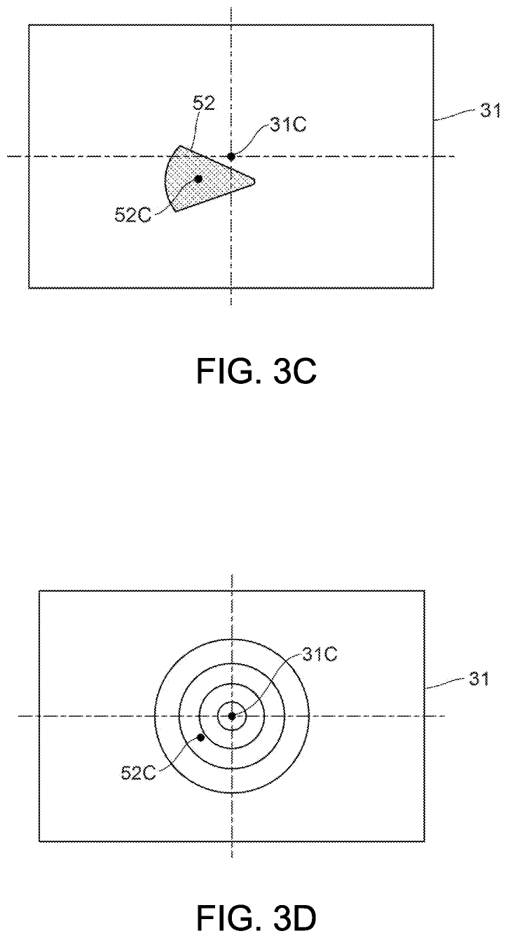

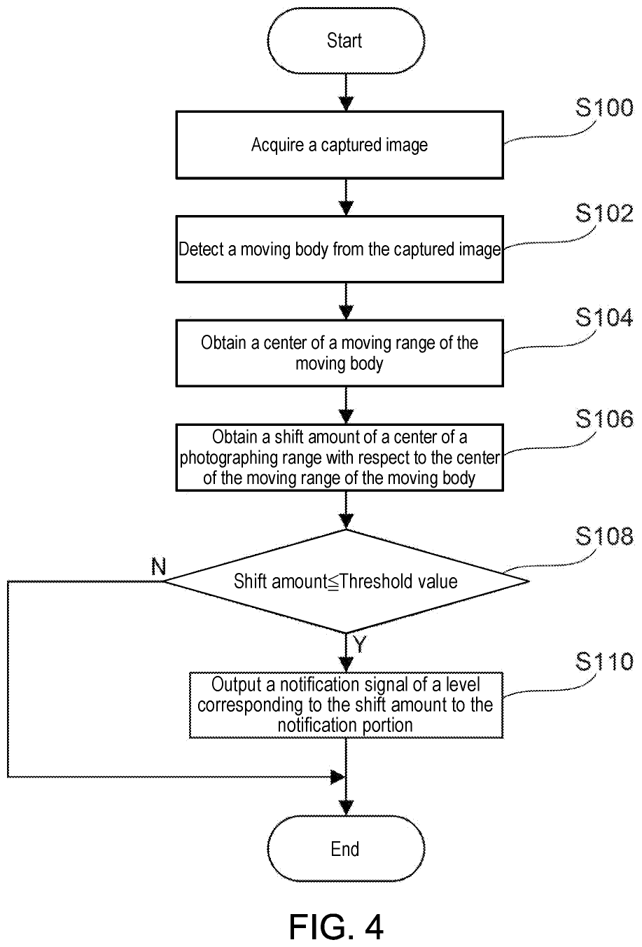

Next, image processing by the CPU 32 is described using FIG. 4. The CPU 32 acquires an image (FIG. 3A) captured by the camera 30 and processed by the image processing portion 44 (step S100).

Next, the CPU 32 detects the moving body 50 from the acquired image (step S102). Specifically, the CPU 32 detects a portion with a large amount of variation in the acquired image as the moving body 50.

Next, the CPU 32 obtains the center 52C of the moving range 52 of the moving body 50 (step S104). Specifically, the CPU 32 first obtains the moving range 52 of the moving body 50 in the acquired image (see FIG. 3B), and then obtains the center 52C from the obtained moving range (see FIG. 3C). It should be noted that when the moving body 50 makes a reciprocating motion, the range of the reciprocating motion (portion with a large amount of variation) is obtained as the moving range 52, and the center 52C is obtained from the obtained moving range 52.

Next, the CPU 32 obtains the shift amount of the center 31C of the photographing range 31 of the camera 30 with respect to the center 52C of the moving range 52 of the moving body 50 (step S106).

Next, the CPU 32 determines whether the shift amount is less than or equal to a predetermined threshold value (step S108). If the shift amount is less than or equal to the predetermined threshold value, the process moves to step S110.

Next, the CPU 32 adjusts the level of the notification signal according to the shift amount (step S110). That is, a notification signal of a level corresponding to the shift amount is output to the notification portion 34. It should be noted that FIG. 3D shows areas (boundaries) in which the level of the notification signal change when the shift amount from the center 52C reaches a predetermined value.

The notification portion 34 adjusts the notification level according to the level of the notification signal and notifies the outside when the notification signal is received from the CPU 32. As mentioned above, the notification level is indicated by the interval and intensity of the sound in the case of the sound notification, the blinking interval and the light intensity in the case of the light notification, and the vibration interval and the vibration intensity in the case of the vibration notification.

It should be noted that the image processing by the CPU 32 described above is a function used when adjusting the mounting position and mounting angle of the camera 30. Thus, when adjusting the mounting position and mounting angle of the camera 30, the image processing by the CPU 32 is repeated at predetermined intervals. As a result, when mounting the camera 30 (image recording device 22), for example, since at least one of sound, light, or vibration notification is transmitted from the notification portion 34 based on the shift amount between the center 31C and the center 52C, mounting operators may easily adjust the mounting position and mounting angle of the camera 30 without displaying the image captured with the camera 30 on the display. Further, even if the mounting position or mounting angle of the camera 30 changes and readjustment is necessary, the readjustment may be easily carried out. It should be noted that the adjustment of the mounting position and mounting angle of the camera 30 mentioned here is an adjustment performed to align the optical axis of the lenses of the camera 30 to a predetermined position.

Next, the function of this embodiment is described. In the photographing system 20 of this embodiment, the CPU 32 output a notification signal when the shift amount of the center 31C with respect to the center 52C is less than or equal to a predetermined threshold value. Upon receiving this notification signal, the notification portion 34 notifies the outside. That is, it may be known that the photographing range by the camera 30 satisfies the predetermined criteria. Thus, with the photographing system 20, the mounting position and mounting angle of the camera 30 may be easily adjusted without displaying the image captured with the camera 30 on the display. In particular, when the CPU 32 adjusts the level of the notification signal according to the shift amount and the notification portion 34 adjusts notification level to the outside in multiple stages according to the notification signal, the mounting position and mounting angle of the camera 30 may be more easily adjusted. As an example, when a sound is emitted from the notification portion 34 based on the shift amount, the operator may be notified in a manner such that the larger the shift amount, the wider the interval between the sounds or the quieter the sound, and the smaller the shift amount, the narrower the interval between the sounds or the louder the sound. By performing the notification in this manner, the operator may mount the camera 30 with higher positional and angular accuracy.

In the photographing system 20 of this embodiment, when the moving body 50 makes a reciprocating motion, the CPU 32 obtains the center 52C by setting the range of the reciprocating motion as the moving range 52. Thus, since it is possible to specify the center of the range of the portion with a large amount of variation in the image acquired by the CPU 32, the accuracy of the mounting position and mounting angle of the camera 30 is improved.

In the photographing system 20 of this embodiment, the notification portion 34 notifies the outside using at least one of sound, light, and vibration. Here, in the case where the notification portion 34 emits a sound or vibration, the operator may easily adjust the mounting position and mounting angle of the camera 30 without looking at the notification portion 34. Further, when the notification portion 34 emits light or vibration, the operator may easily adjust the mounting position and mounting angle of the camera 30 even in the presence of noise.

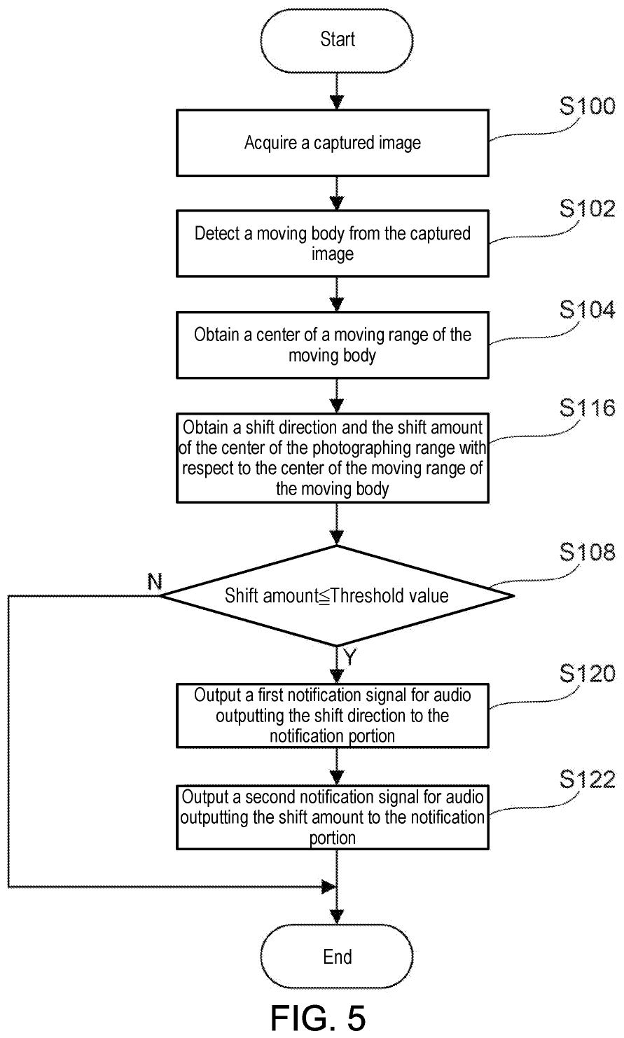

In the embodiment described above, the notification portion 34 is configured to notify the outside using at least one of sound, light, and vibration, but the present disclosure is not limited thereto. For example, the notification portion 34 may be configured to be capable of outputting audio. Further, as shown in FIG. 5, the CPU 32 obtains a shift direction and the shift amount of the center 31C of the photographing range 31 with respect to the center 52C of the moving range 52 of the moving body 50 (step S116), outputs a first notification signal for audio outputting the shift direction from the notification portion 34 as the notification signal (step S120), and outputs a second notification signal for audio outputting the shift amount from the notification portion 34 as the notification signal (step S122). It should be noted that step S120 and step S122 may be interchanged. Specifically, in the case that the center 31C is shifted with respect to the center 52C, the shift amount is output by audio from the notification portion 34 and the shift direction is output by audio from the notification portion 34, which allows easy adjustment of the mounting position and mounting angle of the camera 30. Further, in the above description, the CPU 32 generates information for audio output, but the disclosure is not limited to this configuration. For example, a separate processing portion for audio output may be provided between the CPU 32 and the notification portion 34.

In the above-mentioned embodiment, the CPU 32 performs image processing to obtain the shift amount, or the shift amount and the shift direction, but the disclosure is not limited to this configuration. This image processing may be performed by the image processing portion 44, or a dedicated CPU may be provided separately from the CPU 32 that performs system management of the drive recorder.

In the above-mentioned embodiment, the photographing system 20 has one camera 30, but the photographing system 20 may have multiple cameras. In this case, when the mounting position and mounting angle may be adjusted for each of the cameras, the mounting position and mounting angle of each of the cameras may be easily adjusted by performing image processing by the CPU 32 for each of the cameras. As an example, when the image recording device 22 is a drive recorder, the camera 30 may be used as an outside camera, and another camera 30 may be used as an inside camera.

In the above-mentioned embodiment, the image recording device 22 is used in the vehicle 90, but the disclosure is not limited to this configuration. For example, the image recording device 22 may be used as a monitoring device (so-called surveillance camera) or a security device (security camera). Even in this case, the same function as when used in vehicle 90 may be obtained.

Furthermore, the disclosure is not limited to the above, but may be implemented with various variations other than the above within the scope of not departing from the main purpose of the disclosure.

The following appendix is disclosed below.

### Appendix 1

A photographing system includes: a camera; a processor, processing an image captured by the camera and outputting a notification signal; and a notification portion, notifying an outside that the notification signal has been received. The processor detects a moving body from the image, obtains a center of a moving range of the moving body, and outputs the notification signal when a shift amount of a center of a photographing range of the camera with respect to the center of the moving range of the moving body is less than or equal to a predetermined threshold value.

### Appendix 2

In the photographing system according to Appendix 1, when the moving body makes a reciprocating motion, the processor obtains the center by using a range of the reciprocating motion as the moving range.

### Appendix 3

In the photographing system according to Appendix 1 or Appendix 2, the notification portion is capable of adjusting a notification level to the outside in multiple stages according to the notification signal, and the processor adjusts a level of the notification signal according to the shift amount.

### Appendix 4

In the photographing system according to any one of Appendix 1 to Appendix 3, the notification portion notifies the outside using at least one of sound, light, and vibration.

### Appendix 5

In the photographing system according to Appendix 1, the notification portion is capable of audio output, and the processor obtains a shift direction and the shift amount of the center of the photographing range with respect to the center of the moving range and outputs a first notification signal for audio outputting the shift direction from the notification portion and a second notification signal for audio outputting the shift amount from the notification portion as the notification signal.

### Appendix 6

In the photographing system according to any one of Appendix 1 to Appendix 5, the camera is mounted on a vehicle so as to face forward.

What is claimed is:

1. A photographing system, comprising:
a camera;
a processor, processing an image captured by the camera and outputting a notification signal; and
a notification portion, notifying an outside that the notification signal has been received;
wherein the processor
detects a moving body from the image,
obtains a center of a moving range of the moving body, and
outputs the notification signal when a shift amount of a center of a photographing range of the camera with respect to the center of the moving range of the moving body is less than or equal to a predetermined threshold value.

2. The photographing system according to claim 1, wherein when the moving body makes a reciprocating motion, the processor obtains the center by using a range of the reciprocating motion as the moving range.

3. The photographing system according to claim 1, wherein the notification portion is capable of adjusting a notification level to the outside in multiple stages according to the notification signal, and
the processor adjusts a level of the notification signal according to the shift amount.

4. The photographing system according to claim 1, wherein the notification portion notifies the outside using at least one of sound, light, and vibration.

5. The photographing system according to claim 1, wherein
the notification portion is capable of audio output, and
the processor obtains a shift direction and the shift amount of the center of the photographing range with respect to the center of the moving range and outputs a first notification signal for audio outputting the shift direction from the notification portion and a second notification signal for audio outputting the shift amount from the notification portion as the notification signal.

6. The photographing system according to claim 1, wherein the camera is mounted on a vehicle so as to face forward.
